(19) United States
(12) Patent Application Publication
(10) Pub. No.: US 2002/0005818 A1
(43) Pub. Date: Jan. 17, 2002

(54) Portable processing device comprising a plurality of screen modules of which at least one folding screen module folds over a main screen module

(76) Inventor: Raul Alberto Bruzzone, Le Mans (FR)

Correspondence Address: U.S. Philips Corporation, 580 White Plains Road, Tarrytown, NY, 10591, US

(21) Appl. No.: 09/886,230

(22) Filed: Jun. 21, 2001

(30) Foreign Application Priority Data
Jun. 27, 2000 (FR) 0008269

(51) Int. Cl. G09G 5/00

(52) U.S. Cl. 345/6

(57) ABSTRACT

The invention relates to a device, for example, a mobile personal communicator comprising at least a main screen module and a folding screen module on said main screen module. The main screen module and the folding screen module comprise a sensor for detecting the state of unfolding of the folding screen module. The image to be displayed on the screen is adapted as regards size and resolution to the state of unfolding of the folding module.

The invention thus provides a device that has a screen whose size can be modulated as a function of the applications used.

Applications: portable electronic device with a screen, for example, an organizer, pocket calculator or mobile personal communicator.

### FIELD OF THE INVENTION

The invention relates to a portable processor device comprising a plurality of modules of which at least one screen module folding on another screen module called main module, said device comprising a sensor for detecting the state of opening of the folding module.

The invention finds important applications in the field of mobile telecommunications. The invention particularly applies to mobile personal communicators.

### BACKGROUND OF THE INVENTION

Patent Application No. GB 2 320 591 filed in the United Kingdom, describes a portable device comprising two screen modules folding one on the other. Should the portable device be unfolded, a switch in the hinge is closed, signaling to the device's processor that it must start operating with a full display area.

It is an object of the invention to propose efficient means for controlling the available screen space.

### SUMMARY OF THE INVENTION

A device in accordance with the invention and as described in the opening paragraph is characterized in that said screen modules being capable of displaying a picture comprising one or several window(s), said device comprises display image adapting means for adapting the image to be displayed as a function of said folding state, said display image adapting means being provided for modifying the size of one or several window(s) by keeping a constant height-to-width ratio.

The invention thus proposes a portable device whose screen size may be modified by opening the screen modules. Sensors detect the state of opening of the screen and the image to be displayed is adapted as a function of this state of opening. At any moment the user can thus choose the better compromise between cumbersomeness of the screen and the necessary display area for current applications. For example, if various windows are to be visible simultaneously, it is advantageous to open out various screen modules. Similarly, for applications in which the images contain much text (for reading magazines or newspapers, for example) it is desirable to open out a maximum number of screen modules to improve readability. Conversely, when conventional organizer or telephony applications are used, a small screen will be sufficient.

A device in accordance with the invention advantageously comprises a base screen module and one or more folding screen modules which can be folded onto the base screen module, so that the base screen module is completely covered when the folding screen module(s) is (are) folded. This configuration offers a simple means of protecting the screen when it is not used.

In addition, in an advantageous manner one or various folding screen modules are themselves formed by a main module, a folding module on said main module and a sensor for detecting the state of opening of said folding module. This configuration permits to also augment the modulable nature of the screen.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIGS. 1A to 1D are diagrams of an example of device in accordance with the invention in various states of opening of the folding screen modules,

FIG. 2 is a function diagram of an example of device in accordance with the invention,

FIG. 3 is a diagram of an example of a magnetic sensor used in a device in accordance with the invention,

FIG. 4 is a diagram of an example of an electronic sensor used in a device in accordance with the invention,

FIG. 5 is a diagram giving an outline of an example of a display strategy that can be used by a device in accordance with the invention, and

FIGS. 6A to 6C are diagrams of examples of display for different uses of a device in accordance with the invention.

### DESCRIPTION OF A PREFERRED EMBODIMENT

The device which will now be described by way of example is a personal communicator which utilizes the UMTS standard (Universal Mobile Telecommunications System) for the transmission and reception of data.

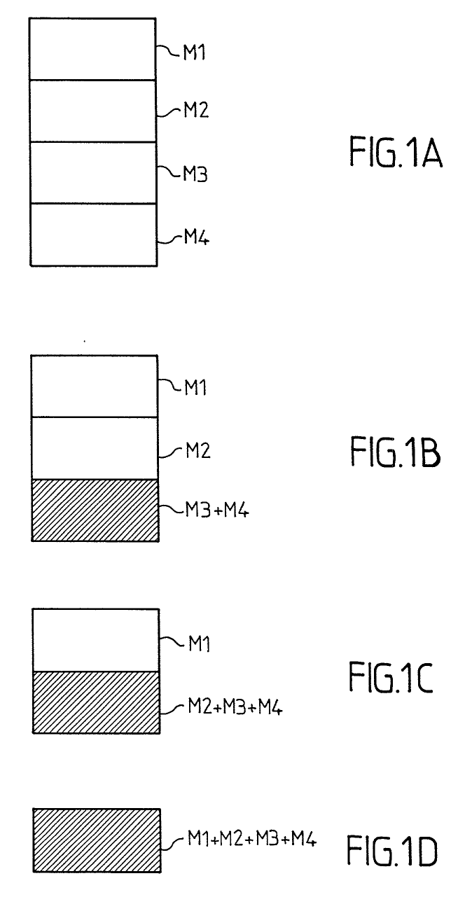

In FIG. 1 is represented an example of a communicator in accordance with the invention in different positions of use. The shaded areas form the screen part which, in the position under consideration, is not operational. This communicator is formed by a screen comprising four modules referred to as M1 to M4.

In FIG. 1A all the modules are opened. The operational surface of the screen is maximum In FIG. 1B the module M4 is folded onto module M3. The operational surface of the screen is equal to half the maximum surface.

In FIG. 1C the modules M3 and M4 are folded onto module M2. The operational surface of the screen is thus equal to ¼ of the maximum surface.

Finally, in FIG. 1D the modules M4, M3 and M2 are folded onto module M1. In this position the module M1 is completely covered, so that the screen is protected against any shocks.

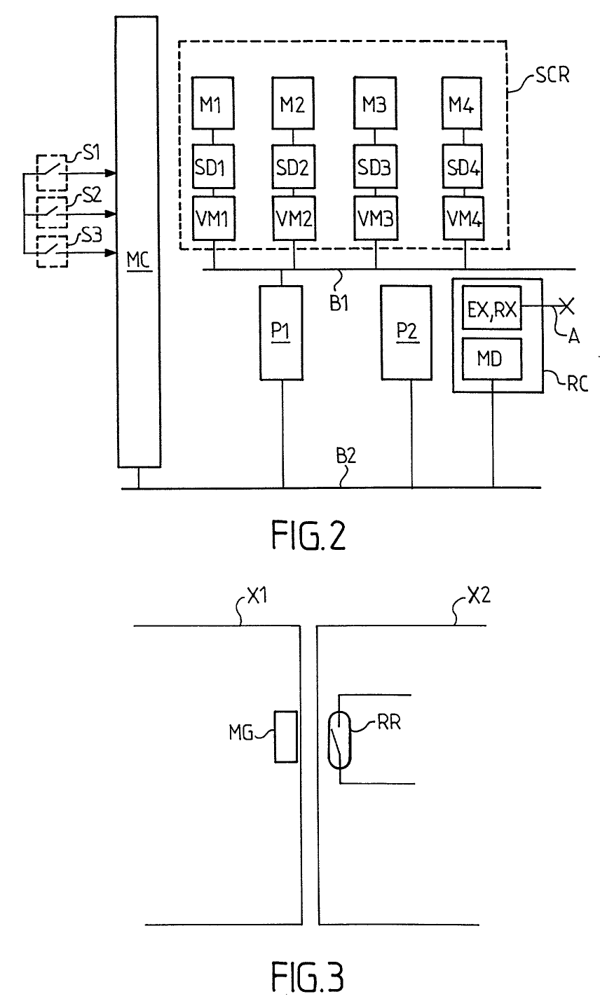

As shown in FIG. 2, a device in accordance with the invention comprises: three sensors S1 to S3 for detecting the state of opening of the screen modules M2, M3 and M4;

a microcontroller MC, which processes the signals coming from the sensors S1 to S3 and certain control functions and signaling functions defined by the UMTS standard;

a data processor PI which codes and decodes audio and/or video data and assembles the images to be displayed on the screen;

an assembly SCR of 4 video memories VM1 to VM4, 4 screen controllers SD1 to SD4 and 4 screen modules M1 to M4; this assembly SCR is connected to the processor P1 by a first bus B1;

an application processor P2 which accommodates an operation system and specific programs such as, for example, an Internet navigator;

a mobile communication module RC which notably comprises a radio transmitter/receiver EX/RX connected to a transmit/receive antenna A, and a radio modem MD connected to the radio transmitter/receiver EX/RX.

The processors P1 and P2, the modem MD of the radio communication module RC and the microcontroller MC are connected by a second bus B2.

In FIG. 3 is shown an example of a sensor for detecting the state of opening of a screen module X1 that can be folded onto a main screen module X2. In this example of embodiment the sensor is a magnetic sensor. It is formed by a reed relay RR arranged on the main screen module X2, and a magnet MG mounted on the folding screen module X1.

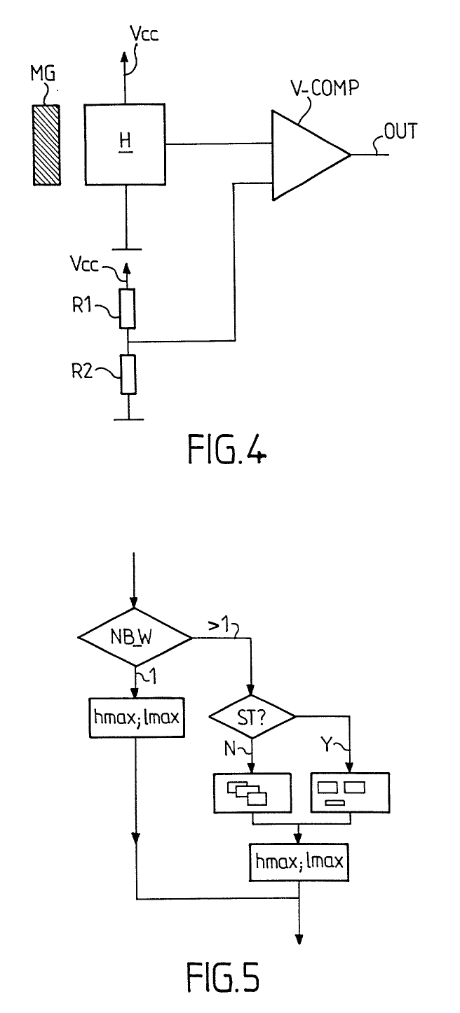

In another embodiment shown in FIG. 4 the sensor is an electronic sensor. This electronic sensor comprises a magnet MG mounted on the folding screen module X1. It also comprises a Hall effect sensor H, a voltage comparator V-COMP and a voltage divider formed by two resistors R1 and R2, the whole mounted on the main screen module X2. The output of the sensor H is carried to a first input of the comparator V-COMP. The other input of the comparator V-COMP receives a reference voltage produced by the voltage divider R1/R2. The output current of the Hall effect sensor is proportional to the intensity of the surrounding magnetic field. When the magnet is close to the sensor H, the current delivered by the sensor H increases. This signal is detected by the voltage comparator V-COMP. The output signal OUT of the voltage comparator V-COMP is a binary signal that is used for indicating the state of opening or non-opening of the folding screen module X1 relative to the main screen module X2. The sensor H is formed, for example, by the integrated circuit T1173L manufactured by Texas Instruments.

Each sensor transmits to the microcontroller a signal that indicates the state of opening of the folding module to which it is associated. The microcontroller regularly reads these signals to update a state memory ST which indicates the global opening state of the device.

The image to be displayed on the screen is processed by the processor P1 based on received windows, as a function of the contents of the state memory ST. Many ways of adapting the image to be displayed on the operational surface of the screen may be devised. In FIG. 5 is shown by way of example in the form of a flow chart a strategy for adapting the image to be displayed. This strategy depends on the number of windows to be simultaneously displayed (NB_W):

If there are several windows to be simultaneously displayed (NB_W >1), the display strategy differs depending on whether the screen is opened up completely or not.

If the screen is completely opened (box Y), the windows are juxatposed (i.e. spread over the available screen surface) on the various parts of the screen.

If not (box N), the windows are superposed (each window may cover the total surface of the screen).

The size of the windows (h;1) is linked with the maximum possible size as a function of the available screen surface and as a function of the number of windows to be displayed while a constant height-to-width ratio (h/l=R) is retained.

While the contents of the state memory ST are updated regularly, it is notably possible to change the configuration during a session.

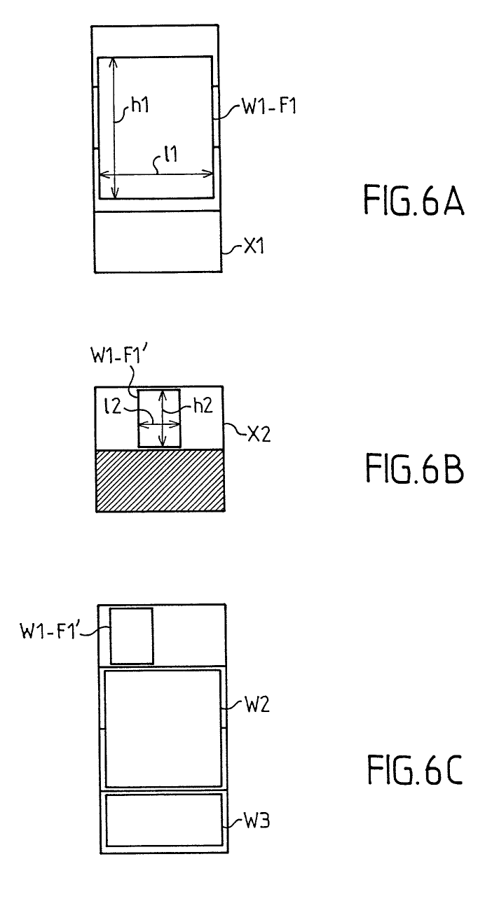

In FIG. 6 are shown examples of display in various configurations of opening of the screen modules. In FIG. 6A all the screen modules are open out and a single window W1 is displayed. The display format F1 of this window W1 is the maximum format authorized by the operational surface X1 of the screen to keep a constant height-to-width ratio (h1/11=R) relative to the received window. In FIG. 6B is shown the display of the same window W1 when the module M2 is the only module that is opened. The format of display F1′ of this window is the maximum format authorized by the operational surface X2 of the screen to keep a constant height-to-width ratio (h2/12=R). In FIG. 6C is represented the simultaneous display of the various windows W1 to W3 on the screen that has completely been opened. The display format of each window is determined so as to keep a constant height-to-width ratio and to make maximum use of the available surface X1.

One will now give examples of applications of a device in accordance with the invention.

First Example: Organization of Holidays

A female person who wishes to organize his holidays utilizes a personal communicator in accordance with the invention to consult the site of a travelling agency. A first small screen offers her various options. The configuration of FIG. 1B is well adapted to this use. In a later phase she receives another screen with a map of possible destinations and she wishes to establish a video conference with a member of her family to ask for his advice on this journey. Various windows will then simultaneously be active. In this case the configuration of FIG. 1A is adapted best.

Second Example: Reading of an Electronic Magazine

A female person who travels by train wishes to buy an electronic magazine at the station. Therefore, she opens her communicator to the position represented in FIG. 1C and she consults the site of the electronic magazine of her choice. She pays with her bank card to download the magazine via an UMTS base station situated at the railway station. Having set down in the train she opens her communicator in the position indicated in FIG. 1A so as to read her magazine. Advantageously, the position of FIG. 1A corresponds to an A4 format.

The invention is not restricted to the embodiments that have just been described by way of example. More particularly, it is not restricted to devices that only comprise screen modules. For example, the invention also applies to a device that comprises one or more keypad modules in addition to the screen modules of the type described above.

The device that has just been described by way of example comprises three folding modules. It will be obvious that the invention is applied to devices having any number of folding modules.

The device that has been described by way of example utilizes the UMTS standard for mobile communications. Although the invention is particularly interesting in the field of mobile telecommunications, it is applicable to other types of equipment, for example, to organizers, or to pocket computers. It may also be applied to personal communicators that use other communication standards, for example, the GPRS standard.

1. A portable processor device (MP, P1, P2) comprising a plurality of modules (1, 2, 2a, 2b, 3, 3a, 3c) of which at least one screen module (2 and 3, 2b, 3b) folding on another screen module called main module (1, 2a, 3a, respectively), said device comprising a sensor (S1, S2, S3, S4) for detecting the state of opening of the folding module characterized in that said screen modules (2) being capable of displaying a picture comprising one or several window(s) said device comprises display image adapting means for adapting the image to be displayed as a function of said folding state (ST, MC, P1), said display image adapting means being provided for modifying the size of one ore several window(s).

2. A device as claimed in claim 1, characterized in that said display image adapting means are provided for determining the size of the windows as a function of the number of window(s) to be displayed simultaneously.

3. A device as claimed in claim 1, characterized in that said display image adapting means are provided for juxtaposing the windows to be displayed in said folding state and for superposing said windows otherwise.

4. A device as claimed in claim 1, characterized in that said sensor is a magnetic sensor.

5. A device as claimed in claim 1, characterized in that said sensor is an electronic sensor.

6. A device as claimed in claim 1, characterized in that it comprises a base screen module and one or more screen folding modules on said base screen module, so that the base screen module is completely covered when the folding screen module(s) is (are) folded up.

7. A device as claimed in claim 1, characterized in that said folding screen module is itself formed by a main module, a folding module on said main module, and a sensor for detecting the state of opening of said folding module.

8. A personal communicator comprising a device as claimed in claim 1.

9. A personal communicator comprising a device as claimed in claim 6.

10. A personal communicator comprising a device as claimed in claim 7.
